(19) United States
(12) Patent Application Publication
(10) Pub. No.: US 2014/0261281 A1
(43) Pub. Date: Sep. 18, 2014

(54) Dry Sump Scavenge Pump System With Balance Shaft Capability For Application To Flat Plane V8 Engines

(71) Applicant: GM GLOBAL TECHNOLOGY OPERATIONS LLC, Detroit, MI (US)

(72) Inventors: Robert Lionel JACQUES, Troy, MI (US); Edward R. ROMBLOM, Dewitt, MI (US)

(73) Assignee: GM GLOBAL TECHNOLOGY OPERATIONS LLC, Detroit, MI (US)

(21) Appl. No.: 13/803,475

(22) Filed: Mar. 14, 2013

(51) Int. Cl. F02B 75/32

(52) U.S. Cl. CPC F02B 75/32
USPC 123/192.2

(57) ABSTRACT

An internal combustion engine includes a balance shaft assembly having a housing mounted to the cylinder block wherein the housing supports a pair of balance shafts rotatably driven by the crankshaft. The pair of balance shafts rotate in opposite directions and each include a hollow tubular body with an internal eccentric mass. A first of the pair of balance shafts is drivingly connected to a drive sprocket at a first end and can include a first drive gear at a second end that is meshingly engaged with a first driven gear at an end of a second of the pair of balance shafts. A first oil pump is provided at the first end of the pair of balance shaft, and a second oil pump is provided at a second end of the pair of balance shafts. The gears of the oil pumps transfer torque between the pair of balance shafts.

### FIELD

The present disclosure relates to a dry sump scavenge pump system with balance shaft capability for balancing engine horizontal shake.

### BACKGROUND

This section provides background information related to the present disclosure which is not necessarily prior art.

Automotive engines typically incorporate a recirculating lubricating system. The lubrication serves not only to reduce friction, and thus wear, between the moving parts, but also to disperse heat, to reduce corrosion and, in the engine, to assist in the sealing action of the piston rings. In many modern engines or transmissions, the lubricating fluid is stored in the pan that normally comprises the lowest part of the crank case. The lubricating fluid is fed by a pump to the moving components and returns by gravity to the sump. In addition to serving as the reservoir, the sump also serves as a cooler because it is normally located in, or in close proximity to, the air stream beneath the vehicle. Because the moving parts can lose considerable energy by virtue of parasitic drag resulting from high speed contact between the moving parts and the lubricating fluid, many high performance vehicles employ a “dry sump” system for the engine. Dry sump systems store the lubricating fluid in a tank or reservoir which may incidentally also function as a cooling radiator. Known dry sump systems deliver the lubricating fluid from the reservoir to the parts to be lubricated by a first pump, and as that fluid collects in the sump, it is generally scavenged from the sump by employing a second pump that returns the fluid to the reservoir in order to maintain the sump essentially dry.

Various engines also utilize balancing systems that balance the vibration forces of the engine. One known specific type of engine that produces sideways or horizontal shake, is the flat plane V8 engine. The term “flat plane” refers to the orientation of the crank pins of the crankshaft being located within a common flat plane. The flat plane crankshaft configuration is distinguished from a dual plan crankshaft configuration that includes crank pins which are offset 90 degrees from one another. One characteristic of the flat plane V8 engine is that it characteristically has an undesirable horizontal shake.

### SUMMARY

This section provides a general summary of the disclosure, and is not a comprehensive disclosure of its full scope or all of its features.

The disclosure of the present application provides a dry sump system that provides a balance shaft functionality that can be used for a flat plane crankshaft configuration or other engine configuration for balancing side shake.

According to the principles of the present disclosure, an internal combustion engine is provided including a cylinder block including a plurality of cylinders, a plurality of pistons disposed in the plurality of cylinders and a crankshaft connected to the plurality of pistons. A balance shaft assembly includes a housing mounted to the cylinder block wherein the housing supports a pair of balance shafts rotatably driven by the crankshaft. The pair of balance shafts rotate in opposite directions and each include a hollow tubular body with an internal eccentric mass. The internal eccentric mass can include a Tungsten alloy or other very heavy material that can allow for a large moment of inertia with a very compact construction. A first of the pair of balance shafts can be drivingly connected to a drive sprocket at a first end and can include a first drive gear at a second end that is meshingly engaged with a first driven gear at an end of a second of the pair of balance shafts. A first oil pump can be provided at the first end of the pair of balance shafts, and a second oil pump can be provided at a second end of the pair of balance shafts. The gears of the oil pumps can be utilized for transferring torque between the pair of balance shafts. It is noted that the disclosure of the present application is particularly applicable to a flat plane V8 engine which exhibits side shake, whereby the balance shaft arrangement can balance the horizontal inertia forces of the engine.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side plan view of an engine having a dry sump scavenge pump system with balance shaft capability, according to the principles of the present disclosure;

FIG. 2 is a perspective view of the dry pump scavenge system with balance shaft capability shown removed from the engine for illustrative purposes;

FIG. 3 is a schematic view of the dry sump scavenge pump system according to a first embodiment of the present disclosure;

FIG. 4 is a schematic view of the dry sump scavenge pump system according to a second embodiment of the present disclosure;

FIG. 5 is a cross-sectional view of a pair of exemplary balance shafts including a force diagram showing the balance shafts balancing the horizontal shake forces of an exemplary engine; and

FIG. 6 is a force diagram similar to FIG. 5 showing the balance shafts balancing the vertical inertia forces of one another.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

With reference to FIG. 1, a portion of an engine 10 is shown including a cylinder block 12 having a plurality of cylinders 14 with a piston 16 provided in each of the cylinders 14. A crankshaft 18 is connected to each of the pistons 16 by a connecting rod 20. The crankshaft 18 can include a drive sprocket 22 that can be drivingly connected to a dry sump scavenge pump system 24 via a chain 26. The dry sump scavenge pump system 24 is designed to be mounted to the bottom of the cylinder block 12 within an oil pan (now shown).

The dry sump scavenge pump system 24 includes a housing 30 that includes a plurality of bearing support regions 32 for rotatably supporting a pair of balance shafts 34A, 34B for rotation therein. As best illustrated in FIG. 2, a first one 34A of the pair of balance shafts 34A, 34B, can include a drive sprocket 36 drivingly connected thereto and engaged by the drive chain 26. The housing 30 can include internal passageways which are fluidly connected to a first oil pump 40 and a second oil pump 42 which are provided at first and second ends of the balance shafts 34A, 34B. The first and second oil pumps 40, 42 communicate with the internal passages within the housing 30 to supply the oil to a secondary reservoir (not shown) from which oil can be pumped directly to lubricate various components of the engine 10.

As illustrated in FIG. 3, the first balance shaft 34A is driven by the drive sprocket and can include a first gear 48 keyed to the shaft 34A that is part of the front scavenge pump 40. At a second end of the first balance shaft 34A, a rear gear 50 is rotatably driven by the first balance shaft 34A and a second rear gear 52 is fixedly mounted to the second balance shaft 34B. Rear gears 50, 52 make up the rear scavenge pump 42. At the front end of the second balance shaft 34B, a further gear 54 can be provided to free spin on the shaft 34B to prevent binding of the two gear sets. The free spinning gear 54 can form part of the front scavenge pump 40 with the gear 48. As an alternative, as shown in FIG. 4, the first balance shaft 34A can be connected to a reversing gear 60 that meshingly engages with a second reversing gear 62 mounted on the second balance shaft 34B in order to load both shafts 34A, 34B. A front scavenge pump 40′ can be driven by the second balance shaft 34B and a rear scavenge pump 42′ can be driven by the second end of the second balance shaft 34B.

In each of the above concepts, the balance shafts 34A, 34B can be formed by a hollow tube-like body and can include an internal eccentric mass within the hollow tubular body, as illustrated in FIG. 5. The internal eccentric mass can include a Tungsten alloy, or other heavy material that allows the balance shafts 34A, 34B to have a small diameter and yet a high moment of inertia due to the heavy eccentric mass disposed therein. As illustrated in FIG. 5, the balance shafts 34A, 34B are designed to rotate at two times the speed of the engine crankshaft 18. The engine crankshaft 18 can be of the flat plane type which creates a horizontal side shake in the engine. The design of the balance shafts are intended to generate an inertia force Fᵢ as illustrated in FIG. 5, that are both headed in the same sideways direction simultaneously so that the combined inertia force F, of each balance shaft 34A, 34B can balance a side inertia force in the opposite direction as created by the crankshaft and piston arrangement that is equal to two times F_{I}, as illustrated in FIG. 5. The balance shafts 34A, 34B rotate in opposite directions so that as one inertia mass is moving in an upward direction to create an upward inertial force, as illustrated in FIG. 6, the other inertia mass of the other balance shaft is moving in the opposite direction so that the forces in the vertical direction balance one another. Therefore, the rotation of the balance shafts counteract the sideways inertia forces of the engine without creating additional vertical force imbalances.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An internal combustion engine, comprising:
a cylinder block including a plurality of cylinders;
a plurality of pistons disposed in said plurality of cylinders;
a crankshaft connected to said plurality of pistons;
a balance shaft assembly including a housing mounted to said cylinder block, said housing supporting a pair of balance shafts rotatably driven by said crankshaft, said pair of balance shafts rotating in opposite directions and each including a hollow tubular body with an internal eccentric mass.

2. The internal combustion engine according to claim 1, wherein said internal eccentric mass includes a tungsten alloy.

3. The internal combustion engine according to claim 1, wherein a first of said pair of balance shafts is drivingly connected to a drive sprocket at a first end and includes a first drive gear at a second end that is meshingly engaged with a first driven gear at an end of a second of said pair of balance shafts.

4. The internal combustion engine according to claim 1, further comprising a first oil pump at said first end of said pair of balance shafts and a second oil pump at said second end of said pair of balance shafts.

5. The internal combustion engine according to claim 1, wherein said crankshaft is a flat plane crankshaft.

6. The internal combustion engine according to claim 5, wherein said pair of balance shafts are driven by said crankshaft at two times a rotational speed of the crankshaft.

7. The internal combustion engine according to claim 1, wherein said pair of balance shafts are configured to balance side shake in a horizontal direction and balance each other in a vertical direction.

8. An internal combustion engine, comprising:
a cylinder block including at least eight cylinders;
a plurality of pistons disposed in said at least eight cylinders;
a flat plane crankshaft connected to said plurality of pistons;
a balance shaft assembly including a housing mounted under said cylinder block, said housing supporting a pair of balance shafts rotatably driven by said crankshaft, said pair of balance shafts rotating in opposite directions and each including a hollow tubular body with an internal eccentric mass.

9. The internal combustion engine according to claim 8, wherein said internal eccentric mass includes a tungsten alloy.

10. The internal combustion engine according to claim 8, wherein a first of said pair of balance shafts is drivingly connected to a drive sprocket at a first end and includes a first drive gear at a second end that is meshingly engaged with a first driven gear at an end of a second of said pair of balance shafts.

11. The internal combustion engine according to claim 8, further comprising a first oil pump at said first end of said pair of balance shafts and a second oil pump at said second end of said pair of balance shafts.

12. The internal combustion engine according to claim 8, wherein said pair of balance shafts are driven by said crankshaft at two times a rotational speed of the crankshaft.

13. The internal combustion engine according to claim 8, wherein said pair of balance shafts are configured to balance side shake in a horizontal direction and balance each other in a vertical direction.

14. An internal combustion engine, comprising:
a cylinder block including a plurality of cylinders;
a plurality of pistons disposed in said plurality of cylinders;
a crankshaft connected to said plurality of pistons;
a combined pump and balance shaft assembly including a housing mounted to said cylinder block, said housing supporting a pair of balance shafts rotatably driven by said crankshaft, said pair of balance shafts rotating in opposite directions, and a first oil pump at a first end of said pair of balance shafts and a second oil pump at a second end of said pair of balance shafts.

15. The internal combustion engine according to claim 14, wherein said pair of balance shafts each include a hollow tubular body with an internal eccentric mass.

16. The internal combustion engine according to claim 15, wherein said internal eccentric mass includes a tungsten alloy.

17. The internal combustion engine according to claim 14, wherein a first of said pair of balance shafts is drivingly connected to a drive sprocket at said first end and includes a first drive gear at said second end that is meshingly engaged with a first driven gear at said second end of a second of said pair of balance shafts.

18. The internal combustion engine according to claim 14, wherein said crankshaft is a flat plane crankshaft.

19. The internal combustion engine according to claim 14, wherein said pair of balance shafts are driven by said crankshaft at two times a rotational speed of the crankshaft.

20. The internal combustion engine according to claim 14, wherein said pair of balance shafts are configured to balance side shake in a horizontal direction and balance each other in a vertical direction.
